(19) United States
(12) Patent Application Publication
(10) Pub. No.: US 2011/0076638 A1
(43) Pub. Date: Mar. 31, 2011

(54) APPARATUS FOR CLEANING TEETH USING A VARIABLE FREQUENCY ULTRASOUND

(75) Inventors: Bart Gottenbos, Budel (NL); John Douglas Fraser, Woodinville, WA (US); Jozef Johannes Maria Janssen, Herten (NL); Benjamin Marty, Boulogne-Billancourt (FR)

(73) Assignee: KONINKLIJKE PHILIPS ELECTRONICS N.V., EINDHOVEN (NL)

(21) Appl. No.: 12/678,358

(22) PCT Filed: Oct. 1, 2008
(86) PCT No.: PCT/IB2008/054001

§ 371 Date: Dec. 3, 2010

Related U.S. Application Data
(60) Provisional application No. 60/978,196, filed on Oct. 8, 2007.

(51) Int. Cl. A61C 17/20; A46B 13/04

(52) U.S. Cl. 433/86; 15/22.1

(57) ABSTRACT

The apparatus includes a source of gas (air) bubbles (14) in a liquid medium, the gas bubbles having a size range which is associated with the size of bacteria alone or in colonies, on teeth or other surfaces. A source of ultrasound signals (16, 18) has a range of frequencies between 200 kHz and 2 MHz, the ultrasound frequency range including the resonance frequencies of a majority of the bubbles. The application of the ultrasound to the bubble/liquid stream directed toward the biofilm on the teeth results in a dislodging/removal of the biofilm.

This invention relates generally to devices for cleaning teeth using ultrasound, and more specifically concerns the combination of a bubble generator and an ultrasound source which vibrates the bubbles at or near their resonant frequency.

Gas bubbles in a liquid such as water results in a vigorous fluid flow when the bubbles are vibrated with ultrasound frequencies at or near the resonance frequency of the bubbles. Such a fluid flow directed toward teeth has the effect of disrupting and removing dental plaque from the teeth. Such a system is the subject of pending PCT patent application No. PCT/IB2006/054463, which is owned by the assignee of the present invention, the contents of which are hereby incorporated by reference. Such devices, however, use a single ultrasound frequency. The bubble generation for such systems must accordingly be quite precise, with the bubbles having a radius matched with the frequency of the ultrasound signal for maximum effect of the ultrasound signal.

In practice, such precise bubble generation is difficult to achieve, particularly in a mass-produced device, since the required precision requires additional expense. The lack of precision in bubble generation leads to bubbles having a range of sizes, which results in a decrease in efficiency of the device, because not all the bubbles can be effectively used for cleaning plaque with a single ultrasound frequency. In addition, the use of a single ultrasound frequency produces a stationary standing wave/interference pattern on the teeth, with the high intensity and the low intensity points of the ultrasound being always in the same position. This typically results in a particular biofilm removal pattern on the teeth, in which certain areas are not cleaned as well as other areas, leaving dental plaque on the teeth in those areas, which is undesirable.

Hence, it is desirable that a bubble generator/ultrasound system be able to effectively make use of a range of bubble sizes, while producing a more homogeneous cleaning of the teeth.

Accordingly, described and shown herein is an apparatus for cleaning biofilm from teeth, comprising: a source of gas bubbles in a liquid medium, the bubbles having a range of sizes associated with effective removal of bacteria in the biofilm, each gas bubble having a resonance frequency; and a source of ultrasound signals having a range of frequencies, the ultrasound frequency range including frequencies corresponding to the resonance frequencies of a majority of the air bubbles, wherein the ultrasound signals are applied to the flow of air bubbles/liquid, vibrating the bubbles so that upon reaching the biofilm, a cleansing action occurs.

Also described and shown herein is a toothbrush, comprising: a toothbrush handle portion; a toothbrush head portion extending from the body portion and having an extending cup-shaped portion; an ultrasound transducer mounted in the cup portion and operably connected to transmit ultrasound waves from the cup portion, focused on teeth surfaces; and a source of gas bubbles in a liquid medium, the bubbles having a size associated with effective removal of bacterial in the biofilm.

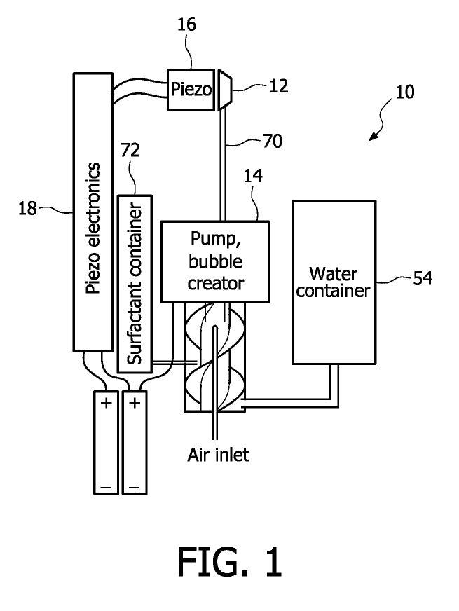

FIG. 1 is a block diagram of the bubble generation/ultrasound apparatus as shown and described herein.

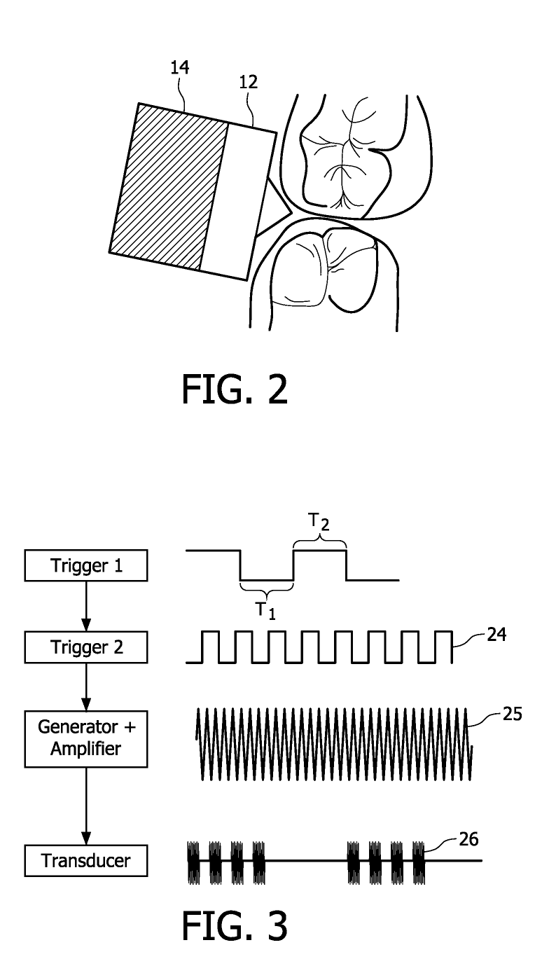

FIG. 2 is a diagram showing a portion of the apparatus positioned in the interproximal area between two teeth.

FIG. 3 is a diagram showing the generation of the ultrasound signal.

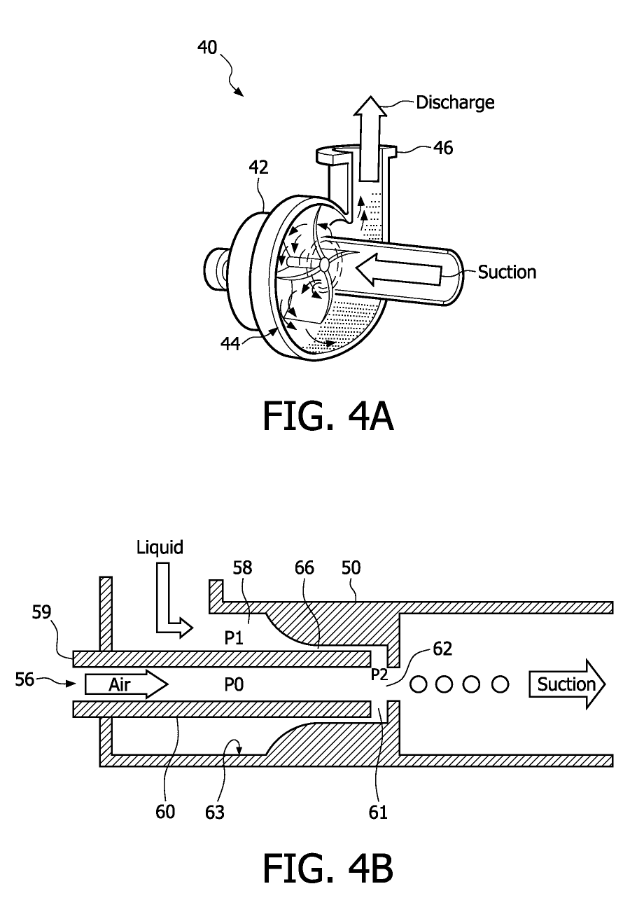

FIGS. 4A and 4B are diagrams showing a system for generating the bubble liquid mixture.

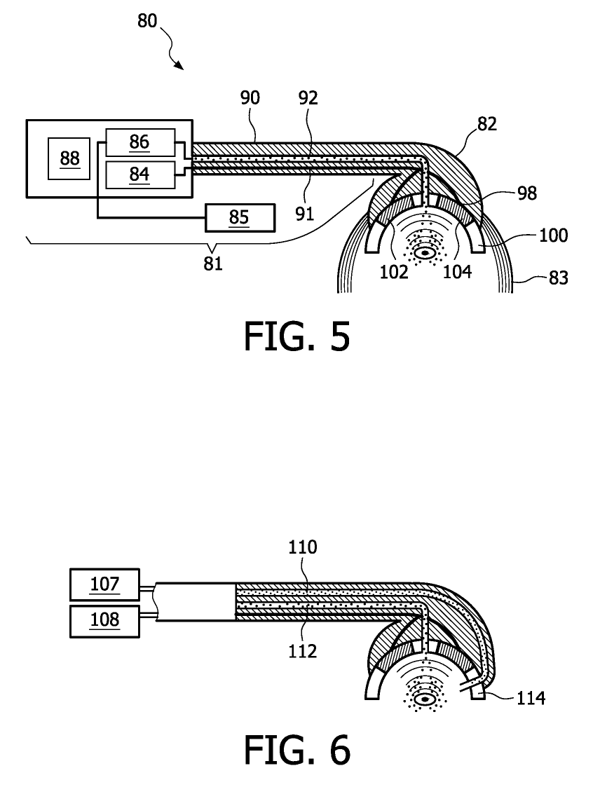

FIG. 5 is an elevational, partially cross-sectional view of a toothbrush embodiment.

FIG. 6 is an elevational, partially cross-sectional view of another embodiment.

The apparatus of FIG. 1, shown generally at 10, when contained partially or completely in a teeth-cleaning device body/casing, including a handle and an extended head, is designed for cleaning teeth and is described in the context of that particular application. However, the principles of the apparatus can be used effectively in other applications, which are discussed below. The apparatus generally combines a bubble generator 14 with a piezoelectric transducer 16 and associated piezoelectric transducer drive electronics 18, referred to as the drive electronics.

Apparatus 10 includes a nozzle/standoff member 12 which is designed to be positioned against the teeth, particularly the interproximal area, to provide a desired spacing between the piezoelectric transducer 16, which produces a range of ultrasound frequencies, and the teeth, specifically to maintain the teeth at or near the focus of the transducer. For instance, at a 400 kHz center frequency of the ultrasound signal, the focus distance is 6.7 mm, for a flat, round transducer 10 mm in diameter. This size will provide good coverage for the teeth surfaces as well as the interproximal space. The range of transducer focus, for instance, for a frequency range of 300-500 kHz, will be 5.1-8.4 mm. The total height of the transducer 16 and standoff member should not be more than 20 mm, which is approximately the size of a regular toothbrush head. From the above, the standoff distance of member 12 will be in the range of 1-15 mm.

If the transducer 16, including the body/casing, has a thickness of 5 mm, the standoff distance is preferably equal to the focus distance of the transducer at the lowest efficient frequency, which in the example above is 5.1 mm. In another example, when the ultrasound frequency varies over a range of 0.75 to 1.25 MHz, with a center frequency of 1 MHz, the focal distance of a flat, round transducer 10 mm in diameter will range from 12.6 mm to 21 mm. The preferred standoff distance is 12.6 mm. This distance can be decreased if the transducer has a non-flat design.

Bubble generator 14 in operation produces a stream of air bubbles in a liquid jet to nozzle member 12. Bubble generator 14 produces bubbles of a range of sizes which are effective in removing dental plaque. In particular, the size of the bubbles will match the size of the bacteria, or colonies/clumps of bacteria, referred to as lumps, present in the biofilm on the teeth. Since the bacteria and/or the lumps have a range of sizes, the bubbles also will have a corresponding size range of bubbles, typically in the micron range. The piezoelectric transducer 16 is designed for broadband ultrasound generation, driven by the drive electronics 18, as mentioned above. The piezoelectric transducer producing a range of frequencies has the advantage of matching the resonant frequencies of a range of bubble sizes, thereby producing effective resonant vibration of a range of bubble sizes as opposed to just one bubble size. This results in effective cleaning for a range of bacteria/bacteria lump sizes, as well as producing homogeneous cleaning effect of the teeth, including the interproximal areas.

More specifically, drive electronics 18 and piezoelectric transducer 16 will produce an ultrasound signal having a selected center frequency, with a particular bandwidth about that frequency. The center frequency can vary over a considerable range. At the low end, the center frequency could be 200 kHz, while at the high end, the center frequency could be 2 or even 4 MHz. A more preferred range is between 200 kHz and 2 MHz, while a preferred center frequency is approximately 1.0 MHz, although a 400 kHz center frequency has also produced good results. In the case of a 1 MHz center frequency, with a bandwidth of 50%, the range of ultrasound frequencies produced will be 750-1250 kHz, while a 50% bandwidth for a 400 kHz center frequency is 300 kHz-500 kHz.

Besides the range of ultrasound frequencies produced by the piezoelectric transducer/drive electronics combination about a selected center frequency, the drive signal produces bursts of ultrasound, instead of a continuous ultrasound signal. FIG. 3 shows the ultrasound signal burst arrangement. The ultrasound signal will be off for a selected time T₁ and on for a selected time T₂. The duty cycle of the ultrasonic signal is controlled by a first trigger control signal (trigger 1). In one embodiment, T₁ and T₂ are equal, each being approximately 1 second. T₁/T₂, however, can vary, typically within a range of 0.1 to 2. Time T₁ (the off time for the ultrasound), however, must be sufficient so that a fresh set of bubbles is present for the next ultrasound wave. Time T₁ will thus depend upon the velocity and the concentration of the bubbles, but will typically be between 10 ms and 1 second, most preferably 100 ms. This T₁ “pause” in the ultrasound is important to prevent agglomeration of bubbles, which tends to occur when the ultrasound signal is continuous or there is insufficient pause (off) time T₁. Preventing agglomeration of bubbles is an important advantage of the present system using ultrasound signal bursts.

Time T₂ contains one or more ultrasound bursts. The frequency of the bursts, indicated at 24-24, can be varied. In one example, the frequency of the bursts ranges between 25 and 600 Hz. This is referred to as the burst repetition frequency (BRF), controlled by a second trigger signal (trigger 2). The lowest possible BRF depends on the value of T₁+T₂, where BRF=1/T₁+T₂, where there is only one burst during T₂. Preferably, the burst repetition frequency is within the range of 100-500 Hz. Most preferably the frequency is approximately 200 Hz. Within each burst, there are a number of individual ultrasound cycles 25 at one ultrasound frequency within the range of frequencies produced by the ultrasound device. In one example, the ultrasound signal frequency in one burst is 1 MHz. The number of cycles within each burst can vary, typically within the range of 50-5000, with a preferred value of approximately 1000. This results in an ultrasound signal pattern indicated at 26 in FIG. 3, comprising successive bursts of an ultrasound signal 30 at a selected ultrasound frequency when the ultrasound device is on (T₂), followed by a pause time (T₁), when the ultrasound device is off.

It should be understood, however, that the above-noted preferred values of T₁, T₂, BRF and the number of cycles per burst are merely illustrative, as the optimal settings are determined by the parameters of the actual flow, including the bubble concentration, bubble size distribution, bubble flow velocity, bubble liquid flow rate and bubble liquid velocity.

The frequency of the ultrasound signal within each time period T₂ can be the same, with the frequency changing for each successive time T₂, or the frequency of the ultrasound signal can change within each time T₂, i.e. in accordance with a pre-selected pattern, as the ultrasound frequency changes over the bandwidth of the ultrasound device.

The optimal frequency range of the ultrasound signal depends on several parameters, including several safety parameters. The lower end of the frequency range is limited by one such safety concern, determined as follows. The amplitude of the ultrasound signal needed for effective removal of biofilm is within the range 0.3-0.5 MPa, referred to peak rarefractional pressure. The peak rarefractional pressure is related to the mechanical index (MI) value associated with the ultrasound signal, which in turn is a good predictor of the likelihood of possible damage to the tissues, including teeth, gum and bones. The mechanical index is defined as follows:

$$MI = \frac{P}{\sqrt{f}}$$

In the use of diagnostic ultrasound, the FDA permits a maximum MI of 1.9. Using a pressure P of 0.5 MPa, which is at the upper end of effective pressure, the resulting lower limit of ultrasound frequency is 69 kHz in order to meet the FDA MI standard.

The intensity of the ultrasound signal is also limited by safety issues. For example, a 1.9 MI would limit the maximum peak rarefractional pressure at a 300 kHz ultrasound signal to 1.0 MPa. This value will change, depending on the actual ultrasound frequency. Further, the FDA maximum time averaged intensity, which takes into account duty cycle, is set at 0.72 W/cm². The intensity I can be calculated from a value of P as follows:

$$I = \frac{{P}^{2}}{2 ρ c}$$

With a continuous wave of ultrasound, and a pressure of 1 MPa, the intensity is 34 W/cm². Accordingly, the maximum duty cycle with those values would be 2.1%. Using 0.5 MPa, the intensity decreases to 8.4 W/cm², which increases the maximum duty cycle value to 8.5%. Hence, duty cycle is important to accommodate safety concerns of pressure and intensity while still producing effective ultrasound action.

The duty cycle can be calculated from the ultrasound driving signal parameters shown in FIG. 3. The burst lengths are calculated from the number of cycles per burst divided by the ultrasound frequency. For example, with an ultrasound frequency of 400 kHz and 1000 cycles per burst, the burst length is 2.5 ms. The duty cycle during T₂ is determined by the burst length (t) and the burst repetition frequency, in particular BRF×(t)/100, in %. The total duty cycle of the system is T₂/T₁+T₂×BRF×(t)/100, in %. For a BRF of 200 Hz, T₁ of 0.2/s and T₂ of 0.03 s, the duty cycle of the system is 10%.

As indicated above, an important aspect of the present system is that the ultrasound generates a range of ultrasound frequencies, in the form of signal bursts of ultrasound, with the range of frequencies being associated with/corresponding to the range of bubble sizes produced by the bubble generator, which in turn is associated with the range of bacterial and/or bacterial lump sizes in the dental plaque biofilm on the teeth.

The bubble generator 14 is shown in more detail in FIGS. 4A and 4B. In general, the bubble generator 14 mixes air and water to produce bubbles. As indicated above, it is important to prevent the agglomeration/aggregation of bubbles during the operation of the apparatus. Accordingly, bubbles are continually produced so that there is always a fresh set of bubbles directed toward the teeth. The rate of bubble agglomeration depends on the bubble flow velocity and concentration and the intensity and duty cycle of the ultrasound signal. In one example of flow velocity, when the bubble liquid is discharged from a nozzle 1 mm in diameter, a flow velocity of 28 cm/s is obtained from a flow rate of 13 ml/min.

The velocity of the bubble mixture is produced by a pump. A continuous flow centrifugal pump is generally preferred, as shown at 40 in FIGS. 4A and 4B. Pump 40 includes a housing 42 and impeller 44 which produces a suction effect for the gas bubbles and liquid introduced into the pump, vigorously mixing them and then directing the resulting fluid bubble mixture to a discharge port 46 connected to the nozzle/standoff element 12. Such centrifugal pumps are well known and commercially available.

The formation of the gas (preferably air) bubble/liquid mixture which moves to the impeller is shown in FIG. 4B. This includes a body portion 50 which includes an opening for fluid from a reservoir 54 (FIG. 1) and an air inlet 56 at a proximal end 59 of an air inlet tube 60. The air inlet 56 is at atmospheric pressure P0. The pressure P1 of the liquid in interior volume 58 surrounding air inlet tube 60 is larger than pressure P0 by a factor which depends upon the height of the liquid level in interior volume 58. The dimensions of interior volume 58 decrease as the interior volume approaches the distal end 61 of the air inlet tube 60. The interior surface 63 of the body portion 50 is spaced a small distance from the distal end 61 of air inlet tube 60. In the embodiment shown, there is a pressure drop between P1 and pressure P2 at outlet 62 of air inlet tube 60, which is larger than the pressure generated by the height of the liquid in the interior volume 58. The dimensions of interior surface 63 of body portion 50 are significant. For example, when outlet opening 62 is 0.3 mm, and the exterior diameter of the inlet tube 60 is 0.6 mm, then the diameter of the interior surface 63 at point 66 should be smaller than 0.67 mm.

The bubble/liquid mixture coming from through outlet 62 is sucked into the impeller, which thoroughly mixes the liquid and air. The resulting flow of bubbles/liquid is then directed into a connecting line 70 to the nozzle/standoff element 12. A soap or a surface active substance (surfactant) can be added to the liquid from a container 72. This reduces the surface tension of the fluid, increasing the number of small bubbles and the uniformity of the bubbles. One example of a suitable surfactant is sodium laurylsulphate, which may be added in an amount of 0.25 m %. This results in optimal surface tension and viscosity. Increasing the viscosity of the liquid increases the shear forces and may have a greater effect against the bacteria on the teeth. It should be understood that FIGS. 4A and 4B illustrate one embodiment for generating a bubble-liquid stream. Many other pumps or similar devices to mix liquid and gas could be used. One alternative way to create a fine bubble mixture is to suck up air and liquid with a pump and then pressurize the mixture in the pump. The air will dissolve in the liquid. When the pressurized air and liquid is released through the nozzle, air bubbles are formed due to the lowered pressure. It is even possible to use a pre-pressurized gas-liquid mixture, for example carbonated fluid-containing pressurized CO₂. At the nozzle, bubbles will be generated that can be employed for dental plaque biofilm removal.

Typical bacteria in dental plaque biofilm are somewhat spherical in shape, with a radius of approximately 4 μm. Since the bacteria are typically very rigid, they may not break under the applied shear stress, particularly if the bubbles are smaller than the bacteria. Hence, the bubbles should typically be greater than the size of the bacteria. It has been found that the bacteria are usually organized in colonies. These colonies or lumps are typically easier to dislodge than the bacteria within the lumps. The colonies can vary between 5 μm and 25 μm in radius. Bubbles in this size range are thus most efficient in effectively and quickly removing bacteria from the teeth.

In operation, bubbles of a desired size are produced by the bubble generator in a continuing stream. The size of the bubbles may vary over a range of +/−30%, which permits the use of a relatively inexpensive bubble generator. A range of bubble size is important and the various bubble sizes, when energized by the ultrasound at their resonant frequencies, operate on a variety of bacteria colony sizes normally encountered in dental plaque. The bubbles are resonated by periodic bursts of ultrasound signals, with the ultrasound having a selected on/off pattern, which tends to prevent aggregation of the bubbles, thus increasing the effectiveness of the plaque removal. Using a range of ultrasound frequencies, besides the advantages of operating effectively on a range of bubble sizes, produces a varying interference pattern on the plaque, which produces a more homogeneous cleaning effect.

As discussed above, the apparatus of FIGS. 1-4 is useful in effective removal of dental plaque bacteria. However, the system can be used for cleaning of other surfaces, including membranes and microchips as well as cleaning of biofilm infections in a variety of applications. The bubble size and the ultrasound frequency range must simply be matched to the size of the bacteria or other item to be removed.

Another embodiment of an oral cleaning device in the form of a toothbrush using gas bubbles and/or vibration of the toothbrush with an ultrasound signal is shown in FIG. 5. In this embodiment, the toothbrush/applicator 80 includes a handle portion 81 and a head portion 82. The handle portion 81 includes piezoelectronics 84, bubble generator 86 and a toothbrush drive circuit 88 for moving the toothbrush head in a selected motion. The toothbrush drive circuit may be used with the gas bubbles and ultrasound or just with ultrasound, or not at all. The toothbrush drive can be any of a number of different drive arrangements to vibrate the head portion 82, which in FIG. 5 is shown with bristles 83. The bubble generator 84 and the piezoelectronics 86 are like that described above for the embodiment of FIGS. 1-4. They can be provided in a separate unit attached to toothbrush 80, if desired. A water container 85 is connected to the bubble generator.

Handle portion 81 includes an elongated section 90 which extends to head portion 82. A wire 91 or similar element carrying the piezoelectric drive signals from piezoelectronics 84 extends through elongated section 90, as does a line 92 for the gas bubble/liquid mixture, from bubble generator 86. Head portion 82 includes a curved surface 98 in which is disposed a cup member 100. Cup member 100 is curved, for instance a prophy cup, which is shaped to focus, i.e. direct, ultrasound waves produced by piezoelectric transducers 102 and 104 positioned on or in the cup member 100 toward the teeth. Cup member 100 is preferably fabricated from a flexible, pliable material, such as rubber or other polymer elastomers. Additional ultrasound transducers can be provided so as to provide a ring of ultrasound transducers around the cup member. The ultrasound transducers are typically located near the middle of cup member 100, as shown.

An opening 106 in the center of cup member 100 provides an exit for the gas bubble/liquid moving through line 92. During operation, opening 106 serves as an outlet for the gas bubbles in the liquid medium, directed toward the target surface, e.g. teeth. The ultrasound waves produced by transducers 102 and 104 are focused toward the target surface by the shape of cup member 100. The ultrasound waves vibrate the bubbles in the liquid medium, as discussed in detail above, producing the desired cleansing bubble action described above. The characteristics of the ultrasound signal discussed above with respect to the embodiments of FIGS. 1-4, including the various possible ranges of frequencies and center frequencies, on/off time and burst rate can also be used in this embodiment, although it should be understood that a single ultrasound frequency can also be used. This provides the good cleaning action with a range of bubble sizes described in detail above.

Bristles 83 are provided on the head portion 82 to provide a brushing action if desired, with a brushhead motion produced by driver circuit 88. The vibrating action can be used with just the ultrasound or with the ultrasound and the gas bubbles.

In addition to the effect of the ultrasound waves acting on the bubbles, which in turn act on the dental plaque for cleaning plaque from the teeth, as discussed above, the gas bubble/liquid can be used to transport the ultrasound waves from the transducer to the teeth for direct action on the dental plaque. The gas bubble/liquid thus acts as a guide for the ultrasound waves. When the successive bursts of ultrasound energy in this arrangement are sufficiently long, a portion of each ultrasound burst will reach the surface of the teeth without much energy loss, producing a desired cleaning effect.

In this arrangement, when water, for instance, is used as a fluid for guiding the ultrasound waves, the fluid needs to be refreshed (replenished) as it escapes from the cup or other openings in the hollow member during operation. In another embodiment, two separate pumps 107, 108 can be used, as shown in FIG. 6, one for pumping a bubble/liquid through line 110, while another pumps liquid without bubbles through line 112. The bubble/liquid, for instance, can be released through the cup member 114 close to the surface of teeth, while the other liquid fills the cup to act as a transport for the ultrasonic waves. As an alternative, gel can be used to fill the cup for transport of the ultrasound. A gel may aid in plaque cleaning as well, since it will mix with the bubble/fluid and increase the viscosity thereof, thereby benefiting the shear forces associated with the cleaning.

With the two-liquid embodiment of FIG. 6, different and otherwise incompatible fluid chemistries can be used, which are mixed just before application to the teeth in the volume defined by the cup member. One example is for teeth bleaching. In the embodiment of FIG. 6, the bubble/liquid supplies bubbles at a sufficient rate to the surface of the biofilm to flush away previous clusters of bubbles, maintaining the site clear for ultrasound action.

Although a preferred embodiment of the invention has been disclosed here for the purposes of illustration, it should be understood that various changes, modifications and substitutions may be incorporated in the embodiment without departing from the spirit of the invention, which is defined by the claims which follow.

1. An apparatus for cleaning biofilm from teeth, comprising:
a source of gas bubbles (14) in a liquid medium, the bubbles having a range of sizes associated with effective removal of bacteria in the biofilm, each gas bubble having a resonance frequency; and
a source of ultrasound signals (16, 18) having a range of frequencies, the ultrasound frequency range including frequencies corresponding to the resonance frequencies of a majority of the air bubbles, wherein the ultrasound signals are applied to the flow of air bubbles/liquid, vibrating the bubbles so that upon reaching the biofilm, a cleansing action occurs.

2. The apparatus of claim 1, wherein the ultrasound signals are generated in an on/off pattern which substantially prevents the agglomeration of the bubbles as they move toward the teeth.

3. The apparatus of claim 2, wherein the on/off pattern is on for 5%-70% of the time.

4. The apparatus of claim 3, wherein the on time is approximately 50% of the time.

5. The apparatus of claim 4, wherein the off time is approximately 0.1 to 1 second.

6. The apparatus of claim 1, wherein the range of bubble size and the frequency range of the ultrasound are associated with the size of the bacteria or bacteria colonies for dislodgement thereof from the teeth.

7. The apparatus of claim 1, wherein the ultrasound signals have a center frequency in the range of 100 kHz to 4 MHz.

8. The apparatus of claim 7, wherein the center frequency has a range of 200 kHz to 2 MHz.

9. The apparatus of claim 7, wherein the center frequency is approximately 400 kHz.

10. The apparatus of claim 7, wherein the center frequency is approximately 1 MHz.

11. The apparatus of claim 3, wherein the ultrasound signals are produced in bursts of ultrasound having a burst repetition rate within the range of 20-200 Hz.

12. The apparatus of claim 11, wherein the number of ultrasound cycles in each ultrasound burst is within the range of 50-5000.

13. The apparatus of claim 1, wherein the ultrasound signals have a bandwidth of approximately 50%.

14. The apparatus of claim 1, including a standoff element (12) which provides a selected distance between the teeth and the ultrasound signal transducer, approximately around the value of the focus of the ultrasound field.

15. The apparatus of claim 1, wherein the radius of the bubbles at rest to their maximum radius at resonance under the effect of the ultrasound is approximately 1:2.5.

16. The apparatus of claim 1, including a supply of surfactant (72) which is added to the liquid in selected amounts for maintaining the bubble size relatively small.

17. The apparatus of claim 2, wherein the velocity of the bubble liquid is within the range of 0.1-10 m/s.

18. An apparatus for cleaning biofilm from a selected surface, comprising:
a source of gas bubbles (14) in a liquid medium, the bubbles having a range of sizes associated with effective removal of bacteria in the biofilm, each gas bubble having a resonance frequency; and
a source of ultrasound signals (16, 18) having a range of frequencies, the ultrasound frequency range including frequencies corresponding to the resonance frequencies of a majority of the gas bubbles, wherein the ultrasound signals are applied to the flow of air bubbles/liquid, vibrating the bubbles so that upon reaching the biofilm, a cleansing action occurs.

19. The apparatus of claim 18, wherein the ultrasound signals are generated in an on/off pattern which substantially prevents agglomeration of the bubbles as they move toward the surface.

20. The apparatus of claim 19, wherein the on/off pattern is on for 5%-70% of the time.

21. The apparatus of claim 18, wherein the range of bubble size and the frequency range of the ultrasound are associated with the size of the bacteria or bacteria colonies for dislodgement thereof from the selected surface.

22. The apparatus of claim 20, wherein the ultrasound signals are produced in bursts of ultrasound.

23. The apparatus of claim 19, wherein the radius of the bubbles at rest to their maximum radius at resonance under the effect of the ultrasound is approximately 1:2.5.

24. A toothbrush, comprising:
a toothbrush handle portion (81);
a toothbrush head portion (82) extending from the handle portion and having an extending cup-shaped portion (100);
an ultrasound transducer (102, 104) mounted in the cup portion and operably connected to transmit ultrasound waves from the cup portion, focused on teeth surfaces; and
a source of gas bubbles (86) in a liquid medium, the bubbles having a size associated with effective removal of bacterial in the biofilm.

25. The toothbrush of claim 24, wherein the source of gas bubbles and drive electronics (84) for the operation of the transducer are contained in the handle portion.

26. The toothbrush of claim 24, wherein the source of gas bubbles and drive electronics (84) for the operation of the transducer are contained in a member outside of but operatively connected to the toothbrush.

27. The toothbrush of claim 24, wherein the toothbrush head includes a plurality of bristles (83) substantially surrounding the head portion.

28. The toothbrush of claim 24, wherein the source of gas bubbles provides a range of bubble sizes and wherein the source of ultrasound signals provide a range of frequencies, wherein the ultrasound frequency range includes frequencies corresponding to the resonance frequencies of a majority of the gas bubbles.

29. The toothbrush of claim 24, wherein the ultrasound signals are generated in an on/off pattern which substantially prevents the aggregation of the bubbles as they move toward the teeth.

30. The apparatus of claim 24, wherein the handle includes a component (88) that vibrates the toothbrush head during operation of the appliance.

31. A toothbrush, comprising:
a toothbrush head (82) having an extending cup-like member (100);
an ultrasonic transducer (102, 104) positioned in the cup-like member to transmit ultrasonic waves therefrom in the direction of the teeth; and
a toothbrush handle (81) operatively connected to the toothbrush head, wherein the handle includes a component (88) which vibrates the toothbrush head during operation of the toothbrush.

32. The toothbrush of claim 31, wherein the cup member comprises a flexible material.

33. The toothbrush of claim 31, including a plurality of ultrasound transducers in the cup member.

34. The toothbrush of claim 31, including a source of gas bubbles (107) in a liquid medium provided to the cup member and directed toward the teeth, and a source of liquid (108) provided to the cup member other than the gas bubble/liquid for aid in directing the ultrasound waves to the teeth.

35. The toothbrush of claim 34, wherein the gas bubble/liquid is released through the cup member close to the teeth.

36. The toothbrush of claim 34, wherein the gas bubble/liquid and the other liquid comprise two incompatible chemistry liquids which mix in the volume defined by the cup member for subsequent application to the teeth.
